(19) United States
(12) Patent Application Publication
(10) Pub. No.: US 2005/0243876 A1
(43) Pub. Date: Nov. 3, 2005

(54) Narrow bandwidth high repetition rate optical parametric oscillator

(75) Inventor: Andy Kung, Taipei (TW)

Correspondence Address: COHEN, PONTANI, LIEBERMAN & PAVANE, 551 FIFTH AVENUE, SUITE 1210, NEW YORK, NY, 10176, US

(73) Assignee: Academia Sinica

(21) Appl. No.: 10/834,755

(22) Filed: Apr. 29, 2004

(51) Int. Cl. H01S 3/10

(52) U.S. Cl. 372/21; 359/330

(57) ABSTRACT

A novel optical parametric oscillator (OPO) directs pulsed optical energy at a first wavelength towards a nonlinear crystal using a wavelength-selective isolation mirror which substantially reflects incident optical energy at the first wavelength, but is substantially transparent to optical energy at a second wavelength. In response to the pulsed optical energy, the nonlinear crystal generates a beam of optical energy at a second wavelength. The beam of generated optical energy is reinforced using an OPO cavity that is formed by the isolation mirror, a diffraction grating, a highly reflecting mirror, and a tuning mirror. The highly reflecting mirror and the tuning mirror provide high reflectivity at the second wavelength. The tuning mirror, positioned so as to at least partially face the diffraction grating, provides an optional wavelength tuning mechanism when the wavelength of the generated optical energy needs to be changed or adjusted. The diffraction grating reflects at least a portion of the beam of generated optical energy out of the OPO cavity as the zeroth order of the diffraction grating. The pump beam passes once through nonlinear crystal, strikes the diffraction grating at an angle of incidence of approximately 87 to 89.5 degrees, and is reflected out of the OPO cavity along with the generated optical energy. An optical filter deflects the pump beam that is reflected out of the OPO cavity, but is substantially transparent to the beam of generated optical energy. An iris aperture, positioned beyond the optical filter, spatially selects the center portion of the beam of generated optical energy from the OPO cavity. The center portion of the beam has a desired narrow bandwidth for use in any of a variety of system applications, so as to provide a broadly tunable, narrow-bandwidth source of pulsed optical radiation.

### BACKGROUND OF THE INVENTION

1. Field of the Invention

This invention relates generally to optical devices and, more particularly, to optical cavity arrangements for producing narrowband pulsed output from a parametric optical medium that is tunable in the mid infrared wavelength range.

2. Description of the Related Art

Optical parametric oscillators (OPO) are nonlinear optical configurations that produce a coherent light beam similar to that produced in a laser device. Presently existing OPO configurations include a nonlinear optical medium, an optical cavity, and components that permit the operator to select a wavelength for the OPO output. Through a process called parametric generation, if a nonlinear optical medium is excited by a powerful laser beam, the medium produces gain over a wide range of wavelengths that are lower than the wavelength of the laser. When this medium is placed in an arrangement of mirrors to provide feedback at one or more wavelengths that exhibit gain, the combination of the medium and the mirrors is referred to as an OPO. Theoretical and experimental aspects of the OPO are well known to skilled artisans. For example, one illustrative OPO is described in U.S. Pat. No. 6,282,014.

One significant advantage of an OPO is that the light it produces is tunable over a wavelength range that is much broader than that obtainable directly from a laser device. An undesirable consequence of this broad gain is that the unfiltered output bandwidth of the OPO is also broad. For pulsed OPOs, the output bandwidth is typically larger than 1 inverse centimeter. Yet, many applications require a narrower bandwidth. OPOs constructed to produce narrower bandwidth require many components, are difficult to set up, and are easily damaged by the pump laser.

U.S. Pat. No. 5,235,456, issued to Guyer et. al., describes a tunable, pulsed, single-longitudinal-mode OPO that utilizes a double-passed pumping arrangement through a nonlinear crystal. A grazing incidence grating filter is employed to reduce the bandwidth of the output. This technique is suitable for visible and near-infrared OPO devices that are pumped by high-powered, single-mode lasers. The narrowband master oscillator described in U.S. Pat. No. 5,457,707, issued to Sobey et al., exhibits shortcomings similar to those of the Guyer device. Furthermore, the output efficiency of the OPO oscillator disclosed in Sobey is low, requiring the addition of external amplifiers to boost output power.

For many system applications, it would be desirable to provide a tunable, low power source of pulsed mid-infrared (IR) optical energy at a high repetition rate, illustratively in the range of 1 KHz to 100 KHz. One possible technique for creating a pulsed source of IR optical energy is to use a diode-laser-pumped pulsed laser as a source of pumping energy. Unfortunately, the Guyer and Sobey devices are not suitable for use as tunable sources in applications which involve pumping by diode-laser-pumped pulsed lasers to provide a low power output at high repetition rates.

Several different types of nonlinear crystals have useful properties in the context of OPO devices. Periodically poled lithium niobate (PPLN), MgO:LN, ZnO:LN, stochiometric lithium niobate (SLN), stochiometric lithium tantalite (SLT), and other similar substances form nonlinear optical crystals that have high nonlinearity and good transmission from the near-ultraviolet (uv) wavelength range to the mid-infrared (ir) wavelength range at 5 microns. PPLN crystals are particularly suitable for OPO operation in the 1.4 micron to 4.5 micron region. Experiments using pulsed lasers with PPLN to provide OPO functionality are summarized in Vodopyanov, Topics Appl. Phys. 89, 141-178 (2003). Additionally, U.S. Pat. No. 6,421,166, issued to Velsko and Yang, discloses the use of diode-laser-pumped Nd:YAG lasers at multiple kHz repetition rates to obtain output from a PPLN OPO.

To obtain narrow bandwidth at the output of an OPO, techniques such as injection seeding or intracavity etalon are commonly employed. However, these techniques provide an undesirably narrow tuning range that is limited by the injecting laser or the coatings on the etalon. Yu and Kung (J. Opt. Soc. Am. B16, 2233-2238 (1999)), and Schlup et. al. (Optics Communications 176 (2), 267-271 (2000)) describe arrangements using a grazing incidence diffraction grating to control the bandwidth of the output. In all of these cases, the pump laser is introduced through an optical component, typically a mirror, that has high transmissivity at the excitation wavelength and high reflection at the signal wavelength in an end-pumped configuration. Such an arrangement requires a mirror change in order to cover the full tuning range permitted by the nonlinear medium. For many applications, such as environmental monitoring, trace gas detection, medical diagnostics using breath analysis, plant growth monitoring, and remote sensing, what is needed is a narrowband infrared source that can continuously tune over a broad range of wavelengths without necessitating any optical component changes as a function of wavelength.

### SUMMARY OF THE INVENTION

A novel optical parametric oscillator (OPO) directs pulsed optical energy at a first wavelength towards a nonlinear crystal using a wavelength-selective isolation mirror which substantially reflects incident optical energy at the first wavelength, but is substantially transparent to optical energy at a second wavelength. In response to the pulsed optical energy, the nonlinear crystal generates a beam of optical energy at a second wavelength. The beam of generated optical energy is reinforced using an OPO cavity that is formed by the isolation mirror, a diffraction grating, a highly reflecting mirror, and a tuning mirror. The highly reflecting mirror and the tuning mirror provide high reflectivity at the second wavelength. The tuning mirror, positioned so as to at least partially face the diffraction grating, provides an optional wavelength tuning mechanism when the wavelength of the generated optical energy needs to be changed or adjusted.

The diffraction grating reflects at least a portion of the beam of generated optical energy out of the OPO cavity as the zeroth order of the diffraction grating. The pump beam passes once through nonlinear crystal, strikes the diffraction grating at an angle of incidence of approximately 87 to 89.5 degrees, and is reflected out of the OPO cavity along with the generated optical energy. An optical filter deflects the pump beam that is reflected out of the OPO cavity, but is substantially transparent to the beam of generated optical energy. An optional iris aperture, positioned beyond the optical filter, spatially selects the center portion of the beam of generated optical energy from the OPO cavity. The center portion of the beam has a desired narrow bandwidth for use in any of a variety of system applications, so as to provide a broadly tunable, narrow-bandwidth source of pulsed optical radiation. Utilization of a relatively wide diffraction grating, a relatively large pump beam size, and an iris aperture, results in a substantial reduction of OPO output bandwidth.

Pursuant to a further embodiment of the invention, the isolation mirror is fabricated of metal or has a metal coating. The nonlinear crystal is fabricated from periodically poled lithium niobate PPLN or a PPLN-like material such as MgO:LN, ZnO:LN, stochiometric lithium niobate (SLN), stochiometric lithium tantalite (SLT), or other similar substances that form crystals having high nonlinearity and transmission from the near-ultraviolet (UV) wavelength range to the mid-infrared (IR) wavelength range. The wavelength filter is provided in the form of a grazing incidence diffraction grating. An optional diagnostic mechanism may be provided for diagnosing the output wavelength from the OPO cavity.

Pursuant to a still further embodiment of the invention, a tuning mechanism is provided for modulating the output wavelength of the OPO. By dithering at least one wavelength selective isolation mirror with a piezoelectric transducer, the output wavelength can be rapidly changed in a controlled manner. Wavelength modulation is an effective means to improve the detection sensitivity in numerous spectroscopic applications of a tunable light source.

The various features of novelty which characterize the invention are pointed out with particularity in the claims annexed to and forming a part of the disclosure. For a better understanding of the invention, its operating advantages, and specific objects attained by its use, reference should be made to the drawings and the descriptive matter which illustrate and describe preferred embodiments of the invention. Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings:

FIG. 1 is a hardware block diagram setting forth an exemplary configuration for an optical parametric oscillator (OPO) constructed in accordance with a preferred embodiment of the invention.

FIG. 2 is a hardware block diagram setting forth an exemplary configuration for pump beam coupling components used in the OPO of FIG. 1

FIG. 3 is a diagrammatic representation showing passage of a pump beam through the nonlinear crystal medium of FIG. 1.

FIG. 4. is a graph showing the bandwidth of the OPO of FIG. 1 obtained by using a grazing incidence grating in the OPO cavity.

FIG. 5 is a graph showing an illustrative wavelength spectrum obtained by scanning the OPO of FIG. 1.

FIG. 6 is a hardware block diagram setting forth an exemplary configuration for a wavelength-modulated OPO equipped to implement photoacoustic spectroscopic measurements.

FIG. 7 is a graph showing an illustrative wavelength spectrum obtained using the wavelength-modulated OPO of FIG. 6.

### DETAILED DESCRIPTION OF THE PRESENTLY PREFERRED EMBODIMENTS

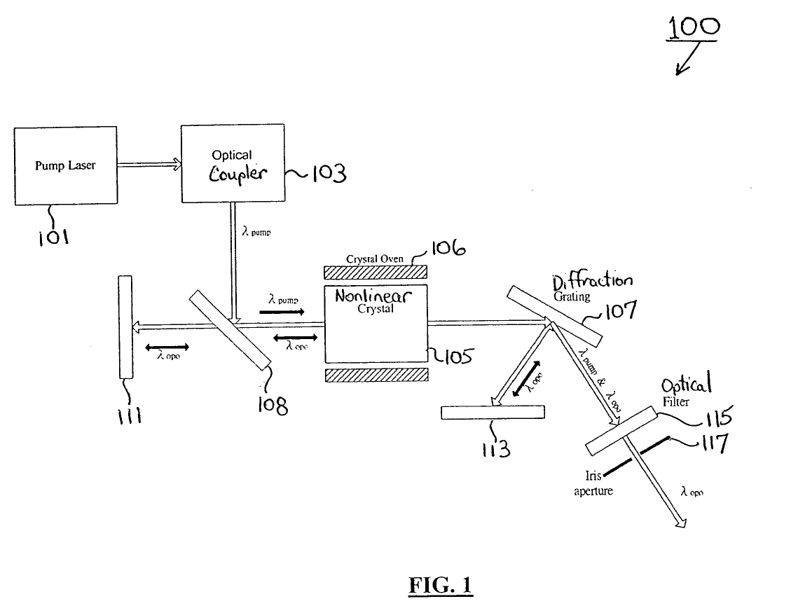

Refer to FIG. 1, which is a hardware block diagram setting forth an exemplary configuration for an optical parametric oscillator (OPO) 100 constructed in accordance with a preferred embodiment of the invention. Pump laser 101 may be implemented using a q-switched diode-laser pumped Nd-YAG laser or, alternatively, any similar type of laser capable of operating at a repetition rate of at least several KHz. The output pulse duration of pump laser 101 is in the range of 5 nanoseconds (nsec) to 100 nsec. The output transverse mode of pump laser 101 is Gaussian or nearly Gaussian. The output longitudinal mode of pump laser 101 can be multiple mode or single mode.

Pump laser 101 generates pulsed optical energy at a first wavelength to provide a pump beam. After passing through an optical coupler 103, the pump beam is incident upon an isolation mirror 108. Isolation mirror 108 directs the pump beam to a nonlinear crystal 105 that is placed inside a temperature-controlled chamber referred to as a crystal oven 106. Isolation mirror 108 is a wavelength-selective mirror which substantially reflects incident optical energy at the first wavelength, but is substantially transparent to optical energy at a second wavelength. In the present example, isolation mirror 108 is fabricated to be highly reflecting at the wavelength generated by pump laser 101, but highly transmitting in the 1.4 micron to 4.5 micron range, thereby reflecting the pump beam from optical coupler 103 into nonlinear crystal 105. The pump beam passes once through nonlinear crystal 105, strikes diffraction grating 107 at an incidence angle of approximately 87 to 89.5 degrees, and is reflected out of an OPO cavity that is formed by diffraction grating 107, isolation mirror 108, a highly reflecting mirror 111, and a tuning mirror 113. Tuning mirror 113 is placed facing diffraction grating 107, and serves as a tuning mirror when the wavelength of an output beam of the OPO cavity needs to be changed or scanned. The output beam of the OPO cavity is coupled from the cavity as the zeroth order of the diffraction grating 107. Between diffraction grating 107 and an optical filter 115, the output beam of the OPO cavity travels in the same direction as the pump beam originating from pump laser 101. The optical filter 115 is used to deflect the exiting pump beam from pump laser 101, and also permits transmission of the output beam from the OPO cavity. An iris aperture 117 is located shortly beyond optical filter 115 to spatially select the center portion of the output beam from the OPO cavity. The center portion of the output beam has a desired narrow bandwidth for use in any of a variety of system applications.

Pursuant to a further embodiment of the invention, the OPO cavity formed by diffraction grating 107, isolation mirror 108, highly reflecting mirror 111, and tuning mirror 113 is implemented as follows. Highly reflecting mirror 111 is implemented using a broadband infrared mirror of gold coated on copper or BK7 glass, in a manner so as to provide greater than 90% reflection in a wavelength range from approximately 1 to 5 microns. Mirror 108 is implemented using a mirror that is coated to reflect highly (reflection coefficient, R, greater than 99.5%) at the pump beam wavelength for an angle of incidence of 45 degrees, plus or minus 10 degrees. The coating on mirror 108 is also designed to be highly transmitting (T>90%) across a broad range of incidence angles in a wavelength range from approximately 1.3 microns to 5 microns. Mirror 108 is located as close as is practicable to the entrance end of crystal oven 106 where the pump beam enters nonlinear crystal 105.

Diffraction grating 107, implemented as a ruled grating blazed for first order diffraction in the wavelength range of 1.4 to 5 microns, is placed at the exit end of the crystal oven. To allow for a short cavity length, diffraction grating 107 is preferably located as close to the oven as is practicable. Diffraction grating 107 is aligned so that the pump beam forms an angle of incidence with the grating surface of between 87 to 89.5 degrees.

Pursuant to the further embodiment of the invention described in the immediately preceding paragraphs, tuning mirror 113 is implemented using a gold- or silver-coated mirror mounted in such a way that the first order (or, in some instances, the second order) diffracted beam from the grating is reflected back into itself to provide optical feedback in the OPO cavity. Accordingly, this tuning mirror 113 serves as the optical tuning element. Since different wavelengths will diffract off the diffraction grating 107 in different directions, by rotating tuning mirror 113, the wavelength that is reflected back to the cavity is changed. Hence, the output wavelength can be tuned in this manner. When used as the sole frequency-tuning element in FIG. 1, tuning mirror 113 provides a tuning range of 20-30 inverse centimeters. A larger tuning range of 100-200 inverse centimeters is obtained by sequentially or simultaneously changing the temperature of the crystal while rotating tuning mirror 113. A motorized device can optionally be attached to the mount of tuning mirror 113 to allow motorized tuning and computerized control of the tuning of the OPO output.

Since the various optical components used in the OPO of FIG. 1 are broadband, the OPO cavity can support resonance at wavelength anywhere between 1.4 microns and 5 microns, as long as there is sufficient parametric gain from the interaction of the pump laser and the crystal. In an illustrative embodiment of FIG. 1, the total optical path between mirror 111 and tuning mirror 113 is about 20 cm long. This distance can be made larger with little effect on the performance of the OPO. Experiment shows that a spacing of smaller than 1 cm between tuning mirror 113 and diffraction grating 107 provides the greatest output power.

Through interaction of the pump beam and nonlinear crystal 105, a signal beam and an idler beam are generated. These three beams (pump beam, signal beam and idler beam) propagate collinearly or nearly collinearly from nonlinear crystal 105 towards diffraction grating 107. These three beams specularly reflect from diffraction grating 107 as shown in FIG. 1 and exit the OPO cavity. The specular reflection is the zeroth order reflection from diffraction grating 107. At grazing incidence, the zeroth order beam has >80% of the incident beam energy. This zeroth order reflection serves as the output coupling of the OPO cavity, and includes a generated beam of optical energy having a wavelength different from the wavelength of the pump beam. The generated beam of optical energy includes at least one of the idler beam and the signal beam. A mirror similar to mirror 108 is used to block out the residual pump beam. An infrared filter can be used to select either the signal beam or the idler beam as a generated beam of optical energy for use in downstream applications. An iris aperture is placed approximately 10 cm from the grating exit and its diameter is adjusted to allow about 70% of the infrared (IR) beam to pass through. This iris has the function to block out infrared (IR) energy that travels in an off-angle direction from the center of the output beam. By nature of the parametric process, this off-angle portion of the output has a wavelength that differs slightly from the center portion, thus undesirably broadening the wavelength resolution of the output.

The OPO described in FIG. 1 provides many advantages over prior art designs. The novel configuration of FIG. 1 is equipped to introduce the pump beam into the OPO cavity using a 45-degree incident dichroic tuning mirror 113 (highly reflecting at 1064 nm and highly transmitting at λ>1.4 μm). Hence, the OPO could be operated over an entire tuning range of, for example, 1.45 μm to 4.0 μm, with a single set of optics. Diffraction grating 107 may be implemented using a 50 mm wide grating that has 300 grooves/mm blazed at 3.0 μm. This grating permits resonating the long wavelength in the OPO cavity formed by tuning mirror 113 and mirror 111. In addition, the iris aperture 117 substantially attenuates the off-axis output radiation which would otherwise comprise the major contributor to a broad pedestal on the output beam and some spectral broadening of the primary bandwidth of the output beam. This spectral broadening is the result of off-axis phase-matching caused by the pump beam which, in practice, is not a perfect plane wave. Implementation of the wider grating, a large pump beam size, and the iris aperture, results in a three-fold reduction of the OPO output bandwidth. When pumped by 4 watts (W) of 1064 nm radiation at 4 kHz this OPO produced 60-100 mW output in the 3.0 μm region with a FWHM bandwidth of typically ˜0.1 cm⁻¹. The output wavelength, being fixed by the grating, is stable for at least several hours to within 20% of the output bandwidth while the root-mean-square (RMS) power stability was better than 5%.

Pursuant to a further embodiment of the invention, by dithering the tuning mirror 113 with a piezoelectric transducer, the output wavelength of the OPO can be rapidly changed in a controlled manner. Wavelength modulation is an effective means to improve detection sensitivity in numerous spectroscopic applications of a tunable light source.

The wavelength range and operational characteristics of the OPO shown in FIG. 1 are particularly suitable for applications in photoacoustic spectroscopy, trace gas analysis using photoacoustic spectroscopy or cavity ring down detection, environmental monitoring, remote sensing, IR microscopy, IR imaging, medical diagnostics using breath analysis or skin emission analysis. In addition, by choosing an appropriate material for nonlinear crystal 105, an appropriate pump laser 101 wavelength, and an appropriate diffraction grating 107, operation may be attained throughout the near infrared and visible wavelength ranges.

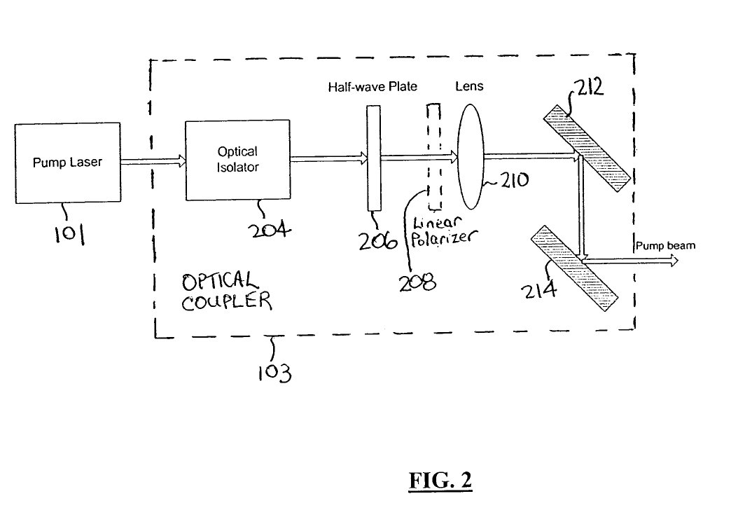

FIG. 2 is a hardware block diagram setting forth an exemplary configuration for the pump laser optical coupler 103 shown in FIG. 1. Optical coupler 103 includes an optical isolator 204 to prevent reflection of the pump beam back into pump laser 101, a half-wave plate 206 to rotate the polarization plane of pump laser 101 to linear polarization, an optional linear polarizer 208, a lens 210 to focus the pump beam to a preferred beam size that is determined by the size of the nonlinear crystal 105 (FIG. 1), and one or more beam steering mirrors 212, 214 that are coated for high reflection at the output wavelength of the pump laser 101 to facilitate alignment of the pump beam through nonlinear crystal 105 (FIG. 1). Another consideration with respect to beam size is the threat of damage to nonlinear crystal 105 from the pump beam and the beams that are generated by the nonlinear crystal itself. For a 1 mm thick PPLN crystal and a pump laser operating at 4 kHz with an average power of 3.5 W at 1064 nm, the beam size at nonlinear crystal 105, measured in terms of a “beam waist”, is 250 microns. A beam waist in the range of 200-300 microns is acceptable. More particularly, beam waist is a cross-sectional measurement of the beam such that 86% of the beam power is contained within a distance of twice the beam waist. The location of the focus of the pump beam should be in the general vicinity of nonlinear crystal 105 and diffraction grating 107 (FIG. 1). The order of arrangement of the aforementioned components is as presented in FIGS. 1 and 2, but the specific configurations and positions of the components could be altered somewhat in practice due to space or design considerations.

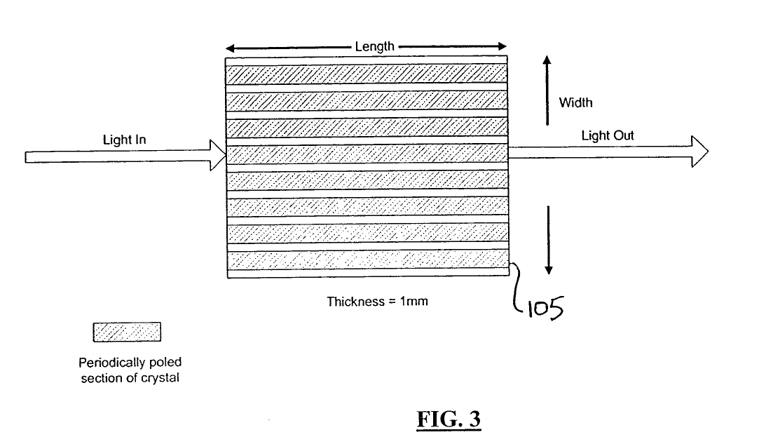

With reference to FIG. 3, nonlinear crystal 105 is fabricated of a material belonging to the periodically poled lithium niobate crystal class. Nonlinear crystal 105 is periodically poled and has segments with a poled periodicity ranging from 26 microns to 32 microns. One such crystal meeting the aforementioned specifications is 1 mm thick and 50 mm long. The ends of nonlinear crystal 105 are optically polished and anti-reflection coated for 1064 nm (R<0.25%) and from 1.4 to 4.5 microns (R<0.5%). Optionally, nonlinear crystal 105 is doped with MgO or ZnO at a concentration of several percent to enhance its resistance to optical damage

Nonlinear crystal 105 is embedded in a temperature-controlled oven that is maintained at a set temperature within +/−0.1 degrees C. The set temperature can be changed if it is desired to change the output wavelength of the OPO of FIG. 1. The typical operating temperature of nonlinear crystal 105 is from 25 degrees to 200 degrees C. FIG. 3 shows the orientation of nonlinear crystal 105 relative to the direction of propagation of pump laser 101 (FIG. 1). The oven for nonlinear crystal 105 is secured on a mount that can manipulate both tilting angles and the xyz translation of the crystal assembly to ensure proper passage of the pump beam through the crystal.

The resolution Δv_{d} of a diffraction grating (FIG. 1, 107) is as follows:

$$Δ {v}_{d} = \frac{1}{πω tan ( α )}$$

where ω is the beam waist of the incident beam and α is the angle of incidence for the incident beam. Observe that, within the OPO cavity, a resonating pulse of optical energy makes N passes while building up its strength before exiting the cavity. Accordingly, the OPO output bandwidth Δvₒₚₒ is given by:

$$Δ {v}_{opo} = \frac{1}{\sqrt{N}} Δ {v}_{d}$$

where N is the number of passes of the resonating pulse during build up inside the OPO cavity. N depends on the pump intensity and the parametric gain obtained from the nonlinear effects of nonlinear crystal 105 (FIG. 1).

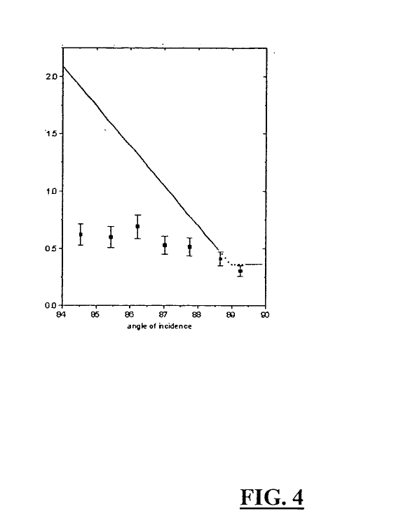

FIG. 4. is a graph showing the bandwidth of the OPO of FIG. 1 obtained by using a grazing incidence grating in the OPO cavity. The solid line represents calculated values, and the points represent measured values. Using a grating blazed with 300 grooves/mm and a blaze angle of 26.743 degrees, a pump beam size of 250 μm, and the iris aperture of <1 mm diameter, the OPO output bandwidth is reduced by more than a factor of ten relative to an OPO which does not use diffraction grating 107 (FIG. 1). When pumped by 4 W (watts) of 1064 nm radiation at 4 kHz, an OPO constructed in accordance with the principles of the present invention produced 60-100 mW output in the 3.0 μm region with a FWHM bandwidth of typically ˜0.1 cm⁻¹.

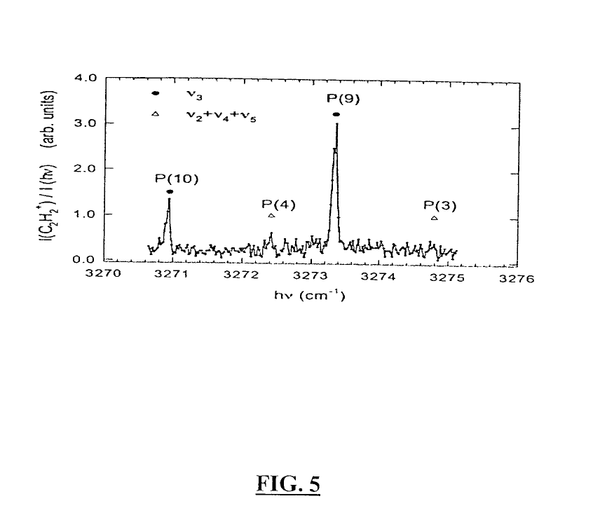

FIG. 5 is a graph showing an illustrative wavelength spectrum obtained by scanning an OPO constructed in accordance with FIG. 1. From the plot of FIG. 5, it is apparent that the OPO provides an 0.1 inverse centimeter bandwidth. Moreover, the output wavelength, being fixed by the diffraction grating, is stable for more than several hours to within 20% of the output bandwidth while the root-mean-square (RMS) power stability is better than 5%.

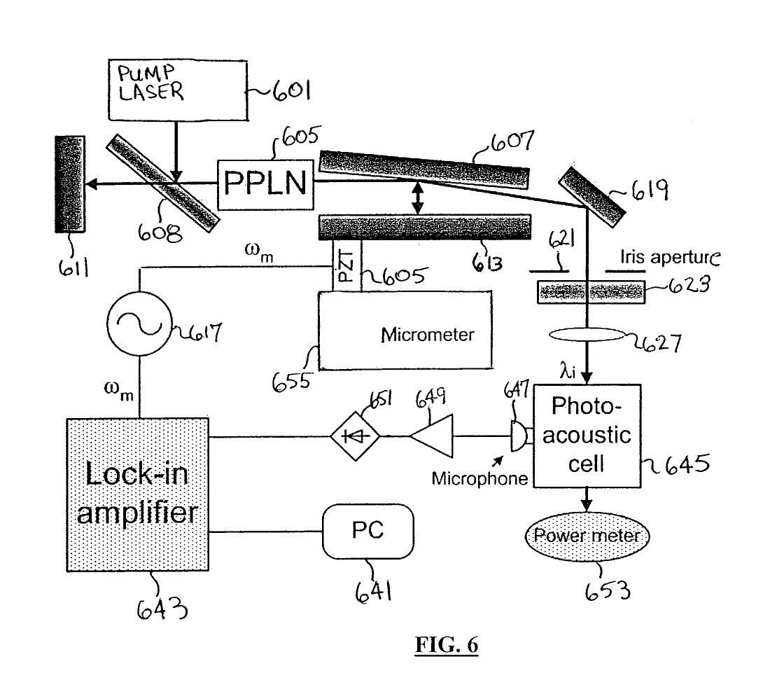

FIG. 6 is a hardware block diagram setting forth an exemplary configuration for a wavelength-modulated OPO equipped to implement photoacoustic spectroscopic measurements. The configuration of FIG. 6 provides a modulation mechanism for modulating the output wavelength of the OPO, illustratively for use in spectroscopic applications. The modulation mechanism includes a piezoelectric crystal (PZT) 605 attached or coupled to a tuning mirror 613. A signal generator 617 applies a sinusoidal voltage to piezoelectric crystal (PZT) 605 to dither tuning mirror 613 in the tuning direction at a modulation frequency of fₘ. The carrier frequency fₐ is equal to the pulse repetition rate of the OPO (4 kHz). The movement of piezoelectric crystal (PZT) 605 is monitored by a micrometer 655. The magnitude of the sinusoidal voltage is adjusted by a computing mechanism, such as personal computer (PC) 641, coupled to a lock-in amplifier 643. PC 641 adjusts the sinusoidal voltage to give the largest demodulated signal as measured using a photoacoustic cell 645 coupled to a microphone 647, an amplifier 649, and an envelope detection diode 651. The envelope detection diode may be implemented using an AD637 diode or the like. Photoacoustic cell 645 is also coupled to a power meter 653 equipped to make power measurements of the signal recovered by photoacoustic cell 645.

The configuration of FIG. 6 is driven by a pump laser 601 which generates 1064-nm optical energy in the form of a pump beam. It is to be understood that the use of a 1064-nm wavelength is for illustrative purposes only, as any of a number of other suitable wavelengths may be employed, and such is within the knowledge of skilled artisans. The pump beam is incident upon a deflection mirror 608. Mirror 608 directs the pump beam to a nonlinear PPLN crystal 605 that is placed inside a temperature-controlled chamber referred to as an oven. Mirror 608 is highly reflecting at the 1064-nm wavelength generated by the pump laser, but is highly transmitting in the 1.4 micron to 4.5 micron range, thereby reflecting the pump beam into nonlinear PPLN crystal 605.

The pump beam passes once through nonlinear PPLN crystal 605, makes an incident angle onto a diffraction grating 607, and is reflected out of an OPO cavity that is formed by diffraction grating 607, mirror 608, a highly reflecting mirror 611, and tuning mirror 613. Tuning mirror 613 is placed facing diffraction grating 607, and serves as a tuning mirror when the wavelength of an output beam of the OPO cavity needs to be changed or scanned. The output beam of the OPO cavity is coupled from the cavity as the zeroth order of the diffraction grating 607. The output beam of the OPO cavity is reflected by a highly reflective mirror 619, and directed towards an iris aperture 621. The iris aperture 621 spatially selects the center portion of the output beam. The center portion of the output beam has a desired narrow bandwidth for use in any of a variety of system applications.

Between highly reflective mirror 619 and a Germanium (Ge) filter 623, the output beam of the OPO cavity travels in the same direction as the 1064-nm pump beam originating from the pump laser. The Ge filter 623 is used to deflect the exiting 1064-nm pump beam originating from the pump laser, and also permits transmission of the output beam from the OPO cavity. After Ge filter 623, the output beam passes through an IR (infrared) lens 627 to focus the output beam on photoacoustic cell 645.

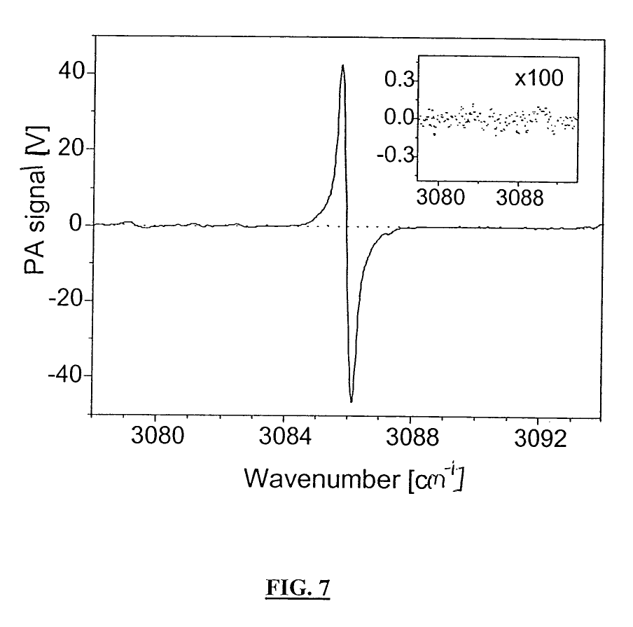

FIG. 7 is a graph showing an illustrative wavelength spectrum obtained using the wavelength-modulated OPO of FIG. 6. The spectrum sets forth a spectral line for methane gas (CH₄).

The invention is not limited by the embodiments described above which are presented as examples only but can be modified in various ways within the scope of protection defined by the appended patent claims. Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit and scope of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

The cited references are herein incorporated in their entirety by reference.

1. An optical parametric oscillator (OPO) for use with a source of pulsed optical energy at a first wavelength, the OPO comprising:
(a) an isolation mirror for substantially reflecting incident optical energy at the first wavelength, but which is substantially transparent to optical energy at a second wavelength;
(b) a nonlinear crystal for responding to optical energy at the first wavelength and incident thereupon, as directed from the isolation mirror, to generate a beam of optical energy at a second wavelength;
(c) an OPO cavity for reinforcing the generated beam of optical energy, wherein the OPO cavity is formed by the isolation mirror, a diffraction grating, a highly reflecting mirror, and a tuning mirror, such that the highly reflecting mirror and the tuning mirror provide high reflectivity at the second wavelength, and such that the tuning mirror is positioned so as to at least partially face the diffraction grating;
wherein the diffraction grating reflects at least a portion of the generated beam of optical energy out of the OPO cavity as the zeroth order of the diffraction grating;
wherein the pump beam passes once through nonlinear crystal, strikes the diffraction grating at an angle of incidence of approximately 87 to 89.5 degrees, and is reflected out of the OPO cavity along with the generated beam of optical energy; and
(d) an optical filter for deflecting the pump beam that is reflected out of the OPO cavity, wherein the optical filter is substantially transparent to the generated beam of optical energy, to thereby provide a source of pulsed optical energy at the second wavelength.

2. The OPO of claim 1 further comprising an iris aperture, positioned beyond the optical filter, for spatially selecting a center portion of the generated beam of optical energy from the OPO cavity.

3. The OPO of claim 1 wherein spacing between the tuning mirror and the diffraction grating is adjusted so as to provide a wavelength adjustment mechanism for adjusting the wavelength of the generated beam of optical energy.

4. The OPO of claim 1 wherein the nonlinear crystal is fabricated from at least one of periodically poled lithium niobate (PPLN), MgO:LN, ZnO:LN, stochiometric lithium niobate (SLN), and stochiometric lithium tantalite (SLT); thereby providing a nonlinear crystal having high nonlinearity and transmission from the near-ultraviolet (UV) wavelength range to the mid-infrared (IR) wavelength range.

5. The OPO of claim 1 wherein the highly reflecting mirror and the tuning mirror are coated to provide high reflectivity over a range of wavelengths, thereby providing an OPO which does not require any mirror changes for operation at any wavelength in the range of wavelengths.

6. The OPO of claim 3 wherein the wavelength adjustment mechanism controls the wavelength of the generated beam of optical energy by dithering the tuning mirror with a piezoelectric transducer.
